(19) United States
(12) Patent Application Publication
(10) Pub. No.: US 2026/0348535 A1
(43) Pub. Date: Nov. 5, 2026

(54) Methods And Systems For Pump Systems For Restrooms

(71) Applicant: PolyJohn Enterprises, LLC, Whiting, IN (US)

(72) Inventor: Petrus Johannes BLIGNAULT, Dubai (AE)

(21) Appl. No.: 19/665,802

(22) Filed: May 1, 2026

Related U.S. Application Data
(60) Provisional application No. 63/800,172, filed on May 5, 2025.

(51) Int. Cl. F17D 1/14; F17D 3/01

(52) U.S. Cl. CPC F17D 1/14; F17D 3/01

(57) ABSTRACT

A vacuum toilet system having a pipe manifold system for vacuum pump setups in restrooms, such as portable restrooms, that allows for efficient blockage removal without system shutdown. When a discharge pump becomes clogged, a parallel, unobstructed pump can be activated. Fluid is directed through a clearance line connecting the two pumps, enabling backflow through the blocked pump. This backflow pushes the obstruction back into the vacuum tank, clearing the blockage without exposing waste or disrupting the vacuum environment.

### CROSS-REFERENCE TO RELATED APPLICATIONS

This application claims the benefit of U.S. Provisional Application No. 63/800,172 filed on May 5, 2025 entitled “METHODS AND SYSTEMS FOR VACUUM PUMP SYSTEMS FOR PORTABLE RESTROOMS”. The entire disclosure of the above application is incorporated herein by reference.

### FIELD

The present disclosure relate to vacuum pump systems and specifically to one or more interconnected discharge pumps.

### BACKGROUND

This section provides background information related to the present disclosure which is not necessarily prior art.

Portable toilets collect waste in tanks. The tanks require periodic emptying. Vacuum assisted toilets improve use suction to remove waste from individual toilets to the tanks. These systems commonly use macerator pumps that grind solids into slurry. However, non-maceratable items can clog the system, requiring manual clearing and resulting in downtime and contamination risks.

Accordingly, needs exist for a vacuum toilet that includes a vacuum pump system operating to assist in removing or reducing clogs.

### SUMMARY

This section provides a general summary of the disclosure, and is not a comprehensive disclosure of its full scope or all of its features.

Example embodiments of the present disclosure relate to vacuum systems. In various embodiments pumps provided and/or used in a parallel configuration allow for ease and efficient line clearance line. This may be by allowing an unobstructed pump to backflush through a blocked pump, dislodging obstructions without needing to shut down or disassemble the system.

Embodiments provide a closed-loop pump manifold configuration that enables selective reverse or back flow through a blocked discharge pump without disassembling or disconnecting various portions of the system and while maintaining a vacuum condition within a vacuum tank. In particular, a clearance line positioned between parallel discharge lines and upstream of downstream isolation (e.g., one way) valves is configured to selectively allow flow generated by an unobstructed discharge pump to be redirected through the clearance line to induce backflow through an obstructed discharge pump and return blockage material to the vacuum tank.

The pumps may be used in a toilet system, which may include a vacuum toilet system. The vacuum toilet system may be useful in portable or non-portable toilet systems. The vacuum toilet system includes one or more toilets fluidly connected to a vacuum tank. In the vacuum tank a vacuum is formed. The vacuum in the vacuum tank may be any appropriate vacuum value relative to the atmospheric or environmental pressure. Generally, the pressure within the vacuum tank is held at a value lower than the atmospheric or environmental pressure.

The vacuum toilet system as presently disclosed includes a vacuum system having vacuum pumps and operating with multiple discharge pumps and/or valves. These multiple portions allow one or more of the discharge pumps, when it becomes clogged, to have valves associated with the multiple pumps be shut off, and a clearance valve between the clogged or obstructed and unclogged unobstructed discharge pumps to be opened, and the unobstructed discharge pump will allow backflow through the obstructed discharge pump to discharge the blockage into the vacuum tank. This also reduces and/or eliminates spilling any waste/sewage out of the vacuum tank, such as the ground, platform, or enclosure (e.g., a trailer).

The disclosed embodiments relate to vacuum systems including vacuum toilet pump systems and methods. In these systems, sewage is drawn into a vacuum tank due to a lower pressure in the vacuum tank than a pressure exterior to the toilets. The vacuum may be formed by one or more vacuum pumps. The one or more vacuum pumps may operate on a duty cycle, with both engaging simultaneously if the vacuum level in the tank drops below a predefined threshold. Once the vacuum tank reaches a set capacity (e.g., threshold level or volume), one or more discharge pumps (which may be internal to the vacuum tank) transfer the sewage through a non-return valve to an external destination, such as a holding tank, sewage infrastructure, or a tanker truck. If a discharge pump becomes blocked, valves on all discharge lines are closed, and a clearance valve between the pumps is opened. The unobstructed pump is then activated, pushing fluid through the clearance line, and creating backflow or backwashing through the obstructed pump, effectively flushing the obstruction back into the vacuum tank.

In specific embodiments, the vacuum toilet pump system may include a vacuum tank, one or more of intake lines which may include one or more discharge pumps, a first line associated with a first discharge pump, a second line associated with a second discharge pump, a clearance valve positioned on a clearance line between the first discharge pump and the second discharge pump, a discharge line, and a tank discharge line with a tank discharge valve.

The vacuum tank is a sealed container, such as a chamber or vessel, designed and configured to hold and/or store waste. It enables rapid collection and transport of waste while helping to prevent exposure to hazardous or toxic materials. In some embodiments, the tank is maintained under vacuum pressure to facilitate efficient movement of the waste material.

The vacuum pump (one or more) are configured to create a vacuum pressure within the vacuum tank, drawing sewage into the vacuum tank through suction alone. Under normal conditions, the one or more vacuum pumps may operate on a duty cycle. This may allow only one pump to run at a time to reduce wear and energy use. However, if the vacuum level falls below a predetermined threshold, all vacuum pumps are activated simultaneously to restore the required vacuum level.

The first discharge line has a proximal end fluidly connected to the vacuum tank and a distal end connected to the discharge line. A first discharge pump is installed to transfer waste from the vacuum tank to the discharge line via the first line. The first discharge pump may be installed at the start of the first line (e.g., a sump pump) or at any appropriate position along the first line. Positioned downstream of the pump is a first valve, which can switch between an open and closed state. When open, the valve allows waste to flow through the line; when closed, it blocks the flow.

The second discharge line is similarly configured, having a proximal end fluidly connected to the vacuum tank and its distal end connected to the discharge line. A second discharge pump is configured to move waste from the tank to the discharge system along the second line. The second discharge pump may be installed at the start of the second line (e.g., a sump pump) or at any appropriate position along the second line. Downstream of the pump is a second valve, which can be opened to allow flow through the line or closed to block it. In embodiments, the second line may be positioned in parallel to the first line.

A clearance line connects the first and second lines at points upstream of their respective valves. This line includes a clearance valve, which remains closed during normal (unobstructed or free flow) operation to prevent flow between the two lines. If one of the first or second discharge pump becomes blocked, both the first and second valves are closed, and the clearance valve is opened. The other of the first or second discharge pump is then activated, pushing fluid through at least the clearance line. This creates backflow through the blocked pump, flushing the obstruction back into the vacuum tank.

The discharge line may be configured to allow sewage to be cleared from the system, such as the vacuum tank, after a selected time (e.g., an event or job). The discharge line may have a proximal end communicatively (e.g., fluidly) coupled to the vacuum tank, and the distal end of the discharge line may be communicatively (e.g., fluidly) coupled with the distal ends of the first line, the second line, and the discharge line vacuum. The discharge line may include a normally closed discharge valve that is configured to remain closed until a job is done. After a job is completed, the discharge valve may be opened, the first valve may be closed, and the second valve may be closed. This may allow sewage within the lines to be vacuumed back into the vacuum tank without any spillage.

In embodiments, the clearance line may operate in two different modes a normal operation mode (when no obstruction is present or detected) and a clearing mode (when an obstruction is present or detected).

In an example embodiment, in the normal operation mode, at least one of the discharge pumps is operated to transfer waste from the vacuum tank through a discharge line while corresponding downstream valves are in an open position, while the clearance valve is in a closed position, such as to prevent cross-flow or communication between the discharge lines.

In the clearing mode, responsive to detection of a blockage condition in one of the discharge pumps, downstream valves associated with both lines are moved to a closed position and the clearance valve is moved to an open position. In this condition, activation of an unobstructed discharge pump causes fluid to flow through the unobstructed line, through the clearance line, and into the obstructed discharge line, thereby generating reverse or back flow through the obstructed discharge pump toward the vacuum tank.

In the clearing mode, the flow path is defined such that fluid discharged from the unobstructed discharge pump is prevented from exiting the system by the closed downstream valves and is instead redirected through the clearance line. The clearance line is positioned upstream of the downstream valves such that the redirected flow enters the obstructed discharge line at a location between the obstructed discharge pump and the corresponding downstream valve. This configuration causes a pressure differential across the obstructed discharge pump sufficient to induce reverse flow through the obstructed discharge pump and into the vacuum tank.

In example embodiments a system is configured to enable blockage removal without breaking system containment of waste, without exposing operators to waste material, and without interrupting the vacuum condition within the vacuum tank. This results in improved operational efficiency, reduced downtime, and enhanced sanitary performance compared to conventional systems requiring disassembly or manual clearing of blockages.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of a vacuum toilet system, according to various embodiments;

FIG. 2 is a detail schematic view of a vacuum tank portion of the vacuum toilet system, according to various embodiments; and

FIG. 3 is a flowchart of an operation of the vacuum toilet system, according to various embodiments.

Corresponding reference numerals indicate corresponding parts throughout the several views of the drawings.

### DETAILED DESCRIPTION

Example embodiments will now be described more fully with reference to the accompanying drawings.

In the following description, numerous specific details are outlined to provide a thorough understanding of the present invention. It will be apparent, however, to one having ordinary skill in the art that the specific detail need not be employed to practice the present invention. In other instances, well-known materials or methods have not been described in detail to avoid obscuring the present invention.

In one example embodiment, a pipe manifold system is disclosed for a vacuum pump setup in a portable or fixed restroom system. The manifold system allows for efficient blockage removal without system shutdown. For example, if a first discharge pump becomes obstructed a second discharge pump that is parallel and unobstructed can be activated. Fluid is directed through a clearance line connecting the two pumps, enabling backflow through the obstructed pump. This backflow pushes the obstruction back into a tank, such as a vacuum tank, clearing the obstructed without exposing waste or disrupting a vacuum environment.

A vacuum tank may be included in various systems. In one example embodiment, a vacuum tank may be fluidly connected to one or more toilets and/or sinks. The vacuum tank may hold a vacuum, which may be a pressure lower than an atmospheric pressure experienced at the inlet at the sinks or the toilets.

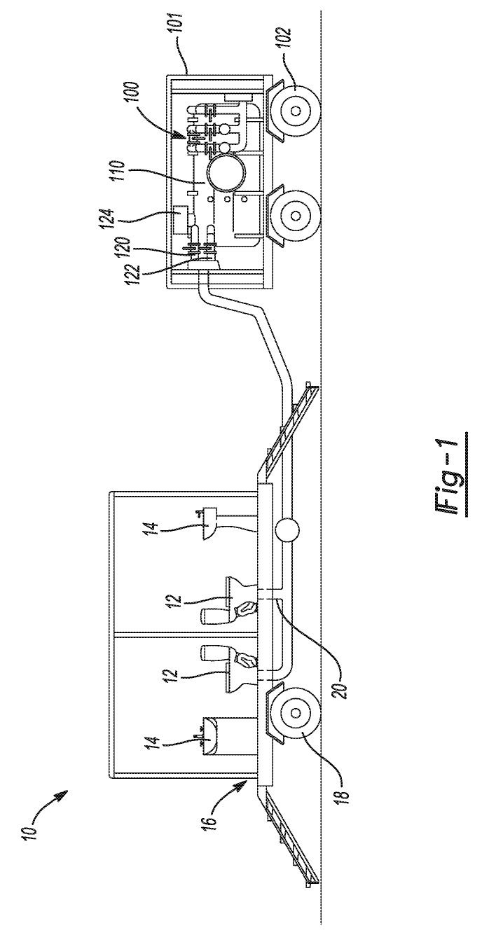

Illustrated in FIG. 1 is a toilet or restroom assembly 10. The toilet assembly 10 may be incorporated into any appropriate embodiment. In one example embodiment, the toilet assembly 10 includes one or more toilets 12, and optionally one or more sinks 14, associated with a mobile platform or system 16, which may include a trailer bed that may be mobile with one or more wheels 18. The toilet assembly 10 may not include a sink 14, in various embodiments. The toilet assembly 10 may be placed in a permanent or portable system. In one example embodiment, a portable system may include an enclosure or enclosed toilet within a substantially portable system such as a PJ part number 101598 provided by PolyJohn Enterprises LLC having a place of business in Whiting, Indiana.

Nevertheless, fluid may flow out of one or more systems, such as the toilet 12, and into a conduit line or more than one conduit line 20. The conduit line 20 may be associated with a manifold system 100. The manifold system 100 may be positioned relative to the toilet assembly 10. For example, the manifold system 100 may be substantially fixed in place or may be mobile, such as in a trailer 101. The trailer 101 may include wheels 102, such that the trailer 101 is mobile. It is understood, however, that the manifold system 100 need not be mobile, but may be positioned relative to any appropriate toilet assembly 10.

In one example embodiment, however, the toilet assembly 10, according to various embodiments, may be mobile and may be moved with or in sequence with the manifold system 100 to a selected location. Thus, the toilet assemblies 10 and/or the manifold system 100 may be selectively positioned for use at a selected location.

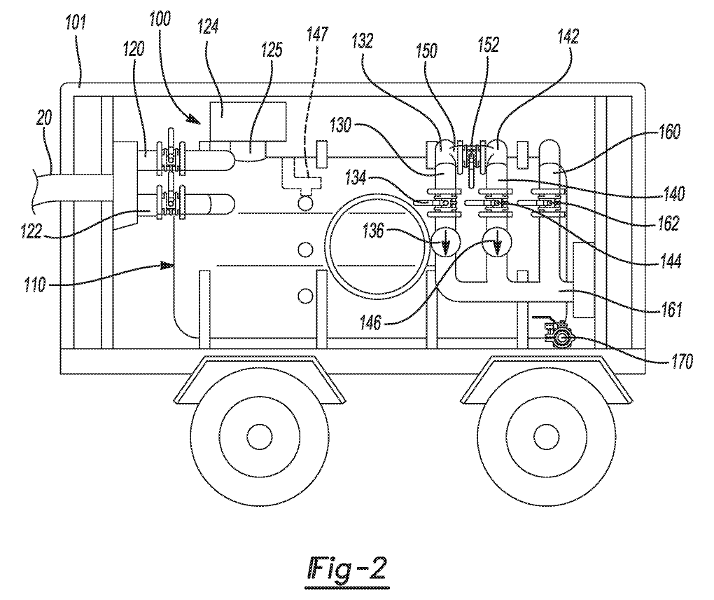

Illustrated in FIG. 2 is a detail view of the manifold system 100. As discussed above, in one example embodiment, the manifold system is configured for portable or mobile toilets. Manifold system 100 may be configured to maintain a vacuum within a vacuum tank 110 while pumps operate on a duty cycle for longevity, and allowing for pumps to be cleared from obstructions (also referred to clogs or blockages) without evacuating the vacuum tank 110 and maintaining the vacuum therein. The vacuum tank may be maintained at any selected vacuum relative to an exterior environmental or atmospheric pressure. Generally, the vacuum tank is at least 5 psi lower than the exterior environmental or atmospheric pressure and/or 5 inches of mercury. One skilled in the art, however, will understanding that the vacuum may be any appropriate lowered pressure.

Manifold system 100 may include the vacuum tank 110, one or more intake lines 120, 122. The intake lines 120, 122 may be individually or separately connected to the lines 20 from the toilet assembly 10. The manifold system 100 further includes a first line 130 associated with a first discharge pump 132 and a second line 140 associated with a second discharge pump 142. A clearance line 150 is between the first discharge pump 132 and the second discharge pump 142. A clearance valve 152 is associated with and configured to open or close (e.g., control) flow through the clearance line 150. The clearance valve 152 may be included in the clearance line 150. A discharge vacuum line 160 and a tank discharge line 161 with a tank discharge valve 170 are also fluidly connected to the vacuum tank 110.

The vacuum tank 110 may be a container, chamber, vessel, etc., that is configured to hold and store waste, such as from the toilets 12 and/or sinks 14 including sewage. The vacuum tank 110 allows for rapid collection and transport of waste. The waste may also be from other sources and, therefore, allow effectively managing hazardous or toxic material from spills and exposure. The vacuum tank 110 may be configured to be held under a vacuum to facilitate waste material movement. In operation, the vacuum tank 110 may have an inlet that is communicatively coupled to other systems, such as one or more toilets 12 that may be connected separately and/or connected in series (e.g., the last of the row of mobile toilets is coupled to the vacuum tank 110). In embodiments, dual freshwater pumps are set in a duty/cycle and duty/assist configuration that will supply the toilets with freshwater, wherein the freshwater system is connected to the vacuum tank 110. This allows the freshwater system to be primed by using the vacuum already present in vacuum tank 110, which permits the freshwater system to be completely vacuumed and all freshwater to be removed, enabling the system to be winterized.

In operation, responsive to one of the mobile toilets being flushed, inlet lines 120, 122 may connect the vacuum tank 110 to the toilet 12 to pull the waste into vacuum tank 110. The vacuum tank 110 may fill to a selected volume or threshold (e.g., in absolute or relative amounts, such as filled to 80%, 85%, 90%, 95%, or any appropriate value), such as a pre-set level. Utilizing the vacuum in the vacuum tank 110 and inlet lines 120, 122, sewage from the toilets 12 may be drawn into vacuum tank 110. In embodiments, an outlet of vacuum tank 110 may be communicably coupled to the line 161 and the discharge valve 170, wherein responsive to the discharge valve 170 being opened, the vacuum tank 110 may drain. In embodiments, vacuum tank 110 may have an internal float switch (not illustrated) that is configured to control the initiation of first discharge pump 142 or second discharge pump 132. Specifically, once the float switch is activated, indicating that vacuum tank 110 is filled to the threshold level, one of the discharge pumps 142, 132 will be initially activated.

The intake lines 120, 122 may be configured to generate a vacuum (e.g., reduced pressure in the intake lines 120, 122 and to the toilets 12) by connection to the vacuum in the vacuum tank 110. The vacuum within the vacuum tank 110 may assist to draw sewage into the vacuum tank by a pure vacuum. In operation, one or more vacuum pumps 124 are configured to vacuum air out of vacuum tank 110, and secure and hold the vacuum tank 110 in a vacuum, as discussed above, via a vacuum forming line 125. The vacuum line 125 may be separated and/or spaced apart from other lines such as the input lines 120, 122 and/or the discharge lines 130, 140. For example, the vacuum pumps 124 may maintain a vacuum within vacuum tank 110 between 10 and 15 inches of mercury. In normal operation, the vacuum pumps 124 may be configured to operate separately and/or sequentially (e.g., on a duty cycle), wherein only one of the vacuum pumps 124 is operating at a time. However, if the vacuum level within the vacuum tank 110 drops below the pre-set level, such as 9 inches of mercury, all of the vacuum pumps 124 may be operated to draw a vacuum within the vacuum tank 110. In embodiments, the vacuum pumps 124 may be in communication with one or more sensors that determine the vacuum level within the vacuum tank 110.

A proximal end of the first line 130 is communicatively (e.g., fluidly) coupled with the vacuum tank 110 and a distal end of the first line 130 is communicatively (e.g., fluidly) coupled with the discharge line 161. A first discharge pump 132 is positioned on the first line 130, wherein the first discharge pump 132 is configured to move material (e.g., waste) from the vacuum tank 110 through the first line 130 to the discharge line 161. The first line 130 may include a first valve 134 positioned after or downstream of the first discharge pump 132. The first valve 134 is configured to move between an open position and a closed position. When the first valve 134 is in the open position material may flow through the first line 130 from the vacuum tank 110 to the discharge line 161. When the first valve 134 is in the closed position material may not flow through the first line 130. A one-way valve 136 may be positioned on the first line 130 after or downstream of the first valve 134. The one-way valve 136 may allow material to move through the first line 130 in a direction from the proximal end to the distal end of the first line 130, but may not allow material to move from the distal end of the first line 130 past the one-way valve 136.

A proximal end of a second line 140 may be communicatively (e.g., fluidly) coupled with the vacuum tank 110, and a distal end of the second line 140 may be communicatively (e.g., fluidly) coupled with the discharge line 161. A second discharge pump 142 may be positioned on the second line 140, wherein the second discharge pump 142 is configured to move material (e.g., waste) from the vacuum tank 110 to the discharge line 161. The second line 140 may include a second valve 144 positioned after or downstream the second discharge pump 142. The second valve 144 is configured to move between an open position and a closed position. In the open position, material may flow through the second line 140, and in the closed position, material may not flow through the second line 140. A one-way valve 146 may be positioned on the first line 140 after or downstream of the second valve 144. The one-way valve 146 may allow material to move through the second line 140 in a direction from the proximal end to the distal end of the second line 140, but may not allow material to move from the distal end of the second line 140 past the one-way valve 146.

In implementations (e.g., during operation of the manifold system 100 with the toilets 12) the first discharge pump 132 and the second discharge pump 142 may operate on a duty cycle to clear material from the vacuum tank 110. For example, when operated, such as manually or automatically, one or more of the discharge pumps 132, 142 may be initiated for a first period of time while maintaining the vacuum within vacuum tank 110. The vacuum is maintained as the vacuum tank 110 is not opened to the atmosphere and/or the vacuum pumps 124 may be operated to maintain the vacuum. The one or more of the discharge pumps 132, 142 may be manually operated, such as by an operator based on a visual inspection and/or signal. The one or more of the discharge pumps 132, 142 may also or additionally be automatically operated, such as based on upon receipt of a signal. The signal may be from threshold fill sensor 147 (e.g., a float valve or sensor) within the vacuum tank 110 indicates that vacuum tank 110 is filled to the threshold level. The signal may be generated and transmitted and/or sent to and/or received at a controller of the one or more of the discharge pumps 132, 142 which may be internal or external thereto.

The one or more of the discharge pumps 132, 142 may be operated simultaneously and/or cycled between each other. For example, the first pump 132 may be operated for a first period of time and then cycled to the second discharge pump 142 for a second period of time while maintaining the vacuum within vacuum tank 110. Responsive to the threshold fill sensor 147 within vacuum tank 110, indicating that vacuum tank 110 isn’t filled to a sufficient level, both first discharge pump 132 and second discharge pump 142 may be turned off.

Both of the first and second valves 134, 144 may remain in the open position if and until there is an obstruction on the first discharge pump 132 or the second discharge pump 142. Once there is an obstruction of the first discharge pump 132 or the second discharge pump 142, both of the first and second valves 134, 144 may be closed, and the clearance valve 152 may be opened.

The clearance line 150 is configured to selectively communicatively (e.g., fluidly) couple the first line 130 and the second line 140 above or upstream of the first valve 134 and the second valve 144. The clearance line 150 may include the clearance valve 152. When there is no obstruction, (i.e., normal operations) the clearance valve 152 may be in a closed position to not allow communication between the first line 130 and the second line 140. However, if there is an obstruction in the first discharge pump 132 or the second discharge pump 142, the first valve 134 and the second valve 144 may be closed, and the clearance valve 152 may be opened. If the first discharge pump 132 is obstructed, once the valves 134, 144 are closed and the clearance valve 152 is open, the second discharge pump 142 may be operated while the vacuum within vacuum tank 110 is maintained, allow and/or force fluid to flow through the second line 140, while closed by the second valve 144, through the clearance line 150, and allowing backflow through the first discharge pump 132 to discharge the blockage into the vacuum tank 110. Similarly, if the second discharge pump 142 is obstructed, once the valves 134, 144 are closed and the clearance valve 152 is open, the first discharge pump 132 may be operated while the vacuum within vacuum tank 110 is maintained, to allow and/or force fluid to flow through the first line 130, while closed by the first valve 134, through the clearance line 150, and allowing backflow through the second discharge pump 421 to discharge the blockage into the vacuum tank 110. To this end, obstructions may be removed from either or both of the discharge pumps 132, 142 without opening the outlet of vacuum tank 110 or removing the vacuum from vacuum tank 110.

The vacuum discharge line 160 may be configured to allow sewage to be cleared from the system external discharge line after operation. The vacuum discharge line 160 may have a proximal end communicatively coupled to the vacuum tank 110, and the distal end of the vacuum discharge line may be communicatively coupled with discharge line 161 and discharge line valve 162, and an external tank or sewer system. In embodiments, responsive to the first discharge pump 132 and/or second discharge pump 142 running, the sewage may be emitted out of the distal end of the discharge line 161 into the external tank or the external system. The vacuum discharge line 160 may include a normally closed discharge valve that is configured to remain closed until a job is done. After a job is completed, the discharge valve 162 may be opened, the first valve 134 may be closed, and the second valve 144 may be closed. This may allow sewage within the lines to be vacuumed back into the vacuum tank 110 without any spillage, such that the lines are clean when system 100 is decoupled from external systems.

Tank discharge valve 170 may be a discharge valve 170 that is configured to be opened to drain the vacuum tank 110 at a lowest or sump region of the vacuum tank 110. After a job is completed and vacuum tank 110 is disconnected from external systems, tank discharge valve 170 may be opened to drain the material from vacuum tank 110.

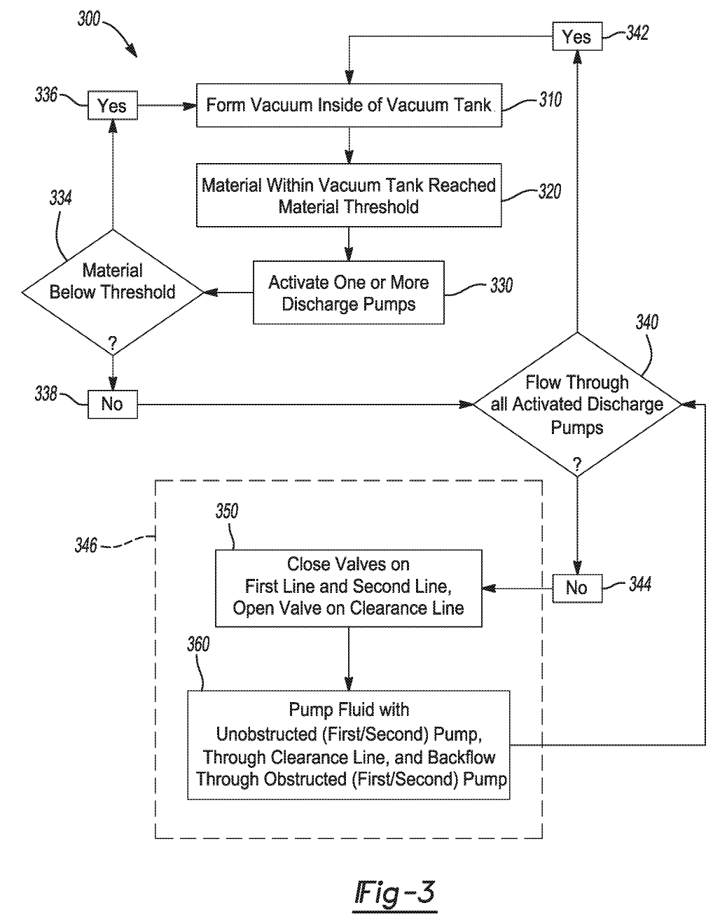

Illustrated in FIG. 3 is a flowchart of a method 300 for operation of the manifold system 100, according to an embodiment. The operations of method 300 presented below are intended to be illustrative. In some embodiments, method 300 may be accomplished with one or more additional operations not described, and/or without one or more of the operations discussed. Additionally, the order in which the operations of method 300 are illustrated and described below is not intended to be limiting.

The method 300 allows for operation of the various components or portions of the system, such as the manifold system 100, discussed above for removal of waste material (e.g., sewage) from the toilets 12 to the vacuum tank 110 and/or clearing of the discharge pumps, as discussed above. At operation 310 one or more of the vacuum pumps 124 are operated to generate a vacuum within the vacuum tank 110, as discussed above. The vacuum formed in the vacuum tank 110 may be utilized to influence and/or assist in and/or draw sewage or waste from one or more of the toilets 12 and/or the sinks 14 to the vacuum tank 110. In selected embodiments, the vacuum is maintained within the vacuum tank 110 by operation of one or more of the vacuum pumps 124 and maintaining of other connections to the vacuum tank 110 in a closed configuration, such as valves being closed, as discussed herein. According to various embodiments, the vacuum may be maintained in the vacuum tank 110 during an operation of the vacuum tank 110, such as during an event or a job. For example, the vacuum tank 110 may be positioned and a vacuum formed therein during an event (e.g. concert, rally, social event, or the like) and maintained during the entirety of the event.

At operation 320 the vacuum tank 110 may be determined to be at a threshold volume or that the material (e.g. waste material) within the vacuum tank has reached a material threshold. As discussed above, the threshold may be any appropriate value, such as an absolute value or relative value of a volume contained by the vacuum tank 110. In addition, the material reaching the threshold amount may be determined based upon manual inspection, automatic determination by the sensor 147 within the vacuum tank 110, combinations thereof, or appropriate alternatives thereto.

Once the material reaches the material threshold in operation 320, activation of one or more of the discharge pumps occurs in operation 330. Thus, the sensing that the threshold is reached may precede or be prior to operation of the discharge pumps. As discussed above, the threshold pumps may be operated simultaneously and/or sequentially. The discharge pumps 132, 142 allow for discharge of material from the vacuum tank 110 through the discharge lines 130, 140, respectively, and passed the valves 134, 144 and the one-way valves 136, 146 to the discharge conduit 161. The discharge pumps may be maintained in operation during the discharge, either simultaneously or individual, such as in sequence, until a determination of whether a material is below a threshold as determined in operation 334. If a determination that the material is below the threshold, a YES path 336 may be followed to the operation 310 to form a vacuum within the vacuum tank. Thus, the method 300 allows for operation of the manifold system 100, including the vacuum tank 110, to maintain the vacuum tank 110 at a selected fill amount and assist in ensuring a lack of an overflow of the vacuum tank 110.

If a determination that the material is not below a threshold, a NO path 338 may be followed to determine whether flow through all the activated discharge pumps is occurring in operation 340. The determination in operation 340 may be by a manual determination (e.g., a user viewing a lack of flow), with a sensor to determine flow past or through the pump, or combinations thereof. If a sensor is present the sensor may transmit a signal to a controller or appropriate system, such as an alarm. In an example embodiment, a controller may be provided to receive a signal from one or more sensors to operate at least one of the first discharge pump or second discharge pump. If a determination that flow is through all of the discharge pumps that are activated, a YES path 342 may be followed to again form vacuum within the vacuum tank in operation 310.

If a determination that flow through the activated discharge pumps is not occurring in operation 340, a NO path, 344 may be followed. The determination that a flow through the activated discharge pumps is not occurring may be made through manual inspection, a flow or pressure sensor, or other appropriate system. Further, the lack of flow or determination that no flow is occurring can be through either/or the pumps 132, 142, the discharge lines 130, 140, the valves 134, 144, or any combination thereof. Regardless if the flow is not occurring, the NO path 344 may be followed to the clearing operation subprocess 346.

The clearing operation subprocess 346 includes closing both of the discharge valves 134, 144 on the discharge lines 130, 140. The operation 350 further includes opening the clearance line valve 152 on the clearance line 150. After both of the discharge valves 134, 144 are closed and the clearance valve 152 is open, then flow of material through the manifold system 100 is between the two pumps 132, 142, through the clearance line 150, rather than through the discharge lines 130, 140 to the discharge line 161. The closing of both of the valves 134, 144 stops outflow of material from the vacuum tank 110.

At operation 360, including operating the unobstructed discharge pump, which may be the first or the second discharge pump, to pump fluid or material through the clearance line 150 to allow backflow of the obstructed discharge pump, which is the other of the first or the second discharge pumps. Thus, the unobstructed pump may be used to backflow or backflush the system, including the obstructed pump. As discussed above, either of the first or second pumps 132, 142 may be the obstructed pump and the other of the discharge pumps 132, 142 may be the unobstructed pump. The operation of the unobstructed pump to backflow the obstructed pump may be made and/or determined manually, automatically, or combinations thereof, such as by inspection, signal from a sensor (e.g., pressure or flow sensor). Regardless, operation of the unobstructed pump may be performed to backflow or move fluid to the obstructed pump. A controller may also be used to receive appropriate signals regarding the obstruction (e.g., lack of flow) and operation of the valves 143, 144, 152, and/or the unobstructed pump and stop operation of the obstructed pump.

The method 300 may then move to the operation 340 to determine whether flow through all activated discharge pumps is occurring. This may include a test operation of all of the discharge pumps at a selected time and include opening the valves 134,144 for the test operation. In any appropriate manner a determination of a flow through all activated discharge pumps may be made in operation 340. If the obstruction still occurs, the NO path 344 may be followed to continue the backflow of the obstruction. If flowing is occurring the YES path 342 may be followed.

Thus, the method 300 allows for determining of an obstruction and/or clearing of an obstruction in the discharge pumps in the manifold system 100.

This allows for a substantially continuous operation of the manifold system 100 and the portable toilet system 10, to allow for an uninterrupted operation of the toilet assembly during an event. Further, as discussed above, the vacuum tank 110 may be discharged at a selected time to ensure that the vacuum tank 110 maintains the selected vacuum therein, and the discharge pumps remain unobstructed and/or the obstruction is fixed if occurred, to allow an uninterrupted operation of the toilet system 10 during a tally or time of an event.

In example embodiments, while clearing the blockage, the closed first valve 134 and the second valve 144 prevent forward or downstream discharge flow such that substantially all flow generated by the activated discharge pump is redirected through the clearance line 150.

In the manifold system 100 may be provide one or more sensors, such as a sensor to determine that at least one of the first discharge line, the first discharge valve, the second discharge line, the second discharge valve, the first discharge pump, or the second discharge pump is obstructed. The one or more sensors may generated and/or transmit a signal. The signal may be to a controller to control one or more of the portions disclosed above. The signal may be to an alarm system to notify a user of a condition of the system 100 to allow an action to be taken, such as to move to the clearance operation mode.

In example embodiments, one or more control systems (e.g., processors) may be provided that are communicatively coupled to one or more sensors configured to detect operating conditions of the system, including vacuum level, pump load, flow rate, or pressure differentials. The control system may also be connected to one or more of the pumps. The control system may be configured to automatically detect a blockage condition based on one or more thresholds and, in response, transition the system from the normal operation mode to the clearing mode by actuating the respective valves and activating the unobstructed discharge pump according to a predefined sequence. One skilled in the art will understand that the pumps and/or valves may include internal or related controls that receive signals from other sensors and/or each other to operate according to the disclosed system and method including, according to various embodiments, the method 300 as disclosed above.

In one example, a pump manifold system for waste material comprises a vacuum tank configured to store the waste material; a first discharge line having a first end fluidly coupled to the vacuum tank and a second end fluidly coupled to a discharge conduit, the first discharge line having a first discharge valve; a second discharge line having a first end fluidly coupled to the vacuum tank and a second end fluidly coupled to the discharge conduit, the second discharge line having a second discharge valve; a first discharge pump configured to move the waste material along the first discharge line from the vacuum tank toward the discharge conduit; a second discharge pump configured to move the waste material along the second discharge line from the vacuum tank toward the discharge conduit; a clearance line fluidly coupling the first discharge line and the second discharge line at a position upstream the first valve and the second valve, the clearance line having a clearance valve.

The pump manifold system may also include in a normal operation mode, the first valve and the second valve are open and the clearance valve is closed to permit flow from the vacuum tank through at least one of the first discharge line or the second discharge line.

The pump manifold system may also include in a clearing mode, the clearance valve is opened.

The pump manifold system may also include in the clearing mode, the first valve and the second valve are closed.

The pump manifold system may also include a first end of the clearance line is positioned between the first discharge pump and the first valve.

The pump manifold system may also include a second end of the clearance line is positioned between the second discharge pump and the second valve.

The pump manifold system may also include in the clearing mode, the first discharge line is obstructed, and fluid flows downstream through the first line, across the clearance line, and upstream within the first discharge line to clear the obstruction.

The pump manifold system may also include the obstruction does not flow through the clearance line.

The pump manifold system may also include the obstruction flows into the vacuum tank.

The pump manifold system may also include the obstruction occurs in the first discharge pump.

The pump manifold system may also include the vacuum tank is configured to maintain a vacuum pressure to draw the waste material from one or more portable restrooms.

The pump manifold system may also include the vacuum pressure is maintained when transitioning between the clearing mode and the normal mode.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1 – 10, or 2 – 9, or 3 – 8, it is also envisioned that Parameter X may have other ranges of values including 1 – 9, 1 – 8, 1 – 3, 1 - 2, 2 – 10, 2 – 8, 2 – 3, 3 – 10, and 3 – 9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, components, and/or groups thereof, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Instructions may be executed by a processor and may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The apparatuses and methods described in this application may be partially or fully implemented by a processor (also referred to as a processor module) that may include a special purpose computer (i.e., created by configuring a processor) and/or a general purpose computer to execute one or more particular functions embodied in computer programs. The computer programs include processor-executable instructions that are stored on at least one non-transitory, tangible computer-readable medium. The computer programs may also include or rely on stored data. The computer programs may include a basic input/output system (BIOS) that interacts with hardware of the special purpose computer, device drivers that interact with particular devices of the special purpose computer, one or more operating systems, user applications, background services and applications, etc.

The computer programs may include: (i) assembly code; (ii) object code generated from source code by a compiler; (iii) source code for execution by an interpreter; (iv) source code for compilation and execution by a just-in-time compiler, (v) descriptive text for parsing, such as HTML (hypertext markup language) or XML (extensible markup language), etc. As examples only, source code may be written in C, C++, C#, Objective-C, Haskell, Go, SQL, Lisp, Java®, ASP, Perl, Javascript®, HTML5, Ada, ASP (active server pages), Perl, Scala, Erlang, Ruby, Flash®, Visual Basic®, Lua, or Python®.

Communications may include wireless communications described in the present disclosure can be conducted in full or partial compliance with one or more IEEE standard 802, including IEEE standard 802.11-2012, IEEE standard 802.16-2009, and/or IEEE standard 802.20-2008. In various implementations, IEEE 802.11-2012 may be supplemented by draft IEEE standard 802.11ac, draft IEEE standard 802.11ad, and/or draft IEEE standard 802.11ah.

A processor, processor module, module or ‘controller’ may be used interchangeably herein (unless specifically noted otherwise) and each may be replaced with the term ‘circuit.’ Any of these terms may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Instructions may be executed by one or more processors or processor modules, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” or “processor module” as used herein may refer to any of the foregoing structure or any other physical structure suitable for implementation of the described techniques. Also, the techniques could be fully implemented in one or more circuits or logic elements.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A pump manifold system for waste material comprising:
a tank configured to store the waste material;
a first discharge line having a first end fluidly coupled to the tank and a second end fluidly coupled to a discharge conduit, the first discharge line having a first discharge valve;
a second discharge line having a first end fluidly coupled to the tank and a second end fluidly coupled to the discharge conduit, the second discharge line having a second discharge valve;
a first discharge pump configured to move the waste material along the first discharge line from the tank toward the discharge conduit;
a second discharge pump configured to move the waste material along the second discharge line from the tank toward the discharge conduit; and
a clearance line fluidly coupling the first discharge line and the second discharge line at a position upstream of the first valve and the second valve, the clearance line having a clearance valve.

2. The system of claim 1, further comprising:
a vacuum pump configured to generate a vacuum in the tank.

3. The system of claim 2, further comprising:
a vacuum line fluidly coupling the vacuum tank and the vacuum pump;
wherein the vacuum line is spaced apart from the first discharge line and the second discharge line.

4. The system of claim 1, further comprising:
the discharge conduit configured to allow discharge from the tank.

5. The system of claim 1, wherein the first discharge valve and the second discharge valve are configured to be simultaneously closed to stop downstream flow through both of the first discharge line and the second discharge line past respective the first discharge valve and the second discharge valve.

6. The system of claim 5, further comprising:
only one of the first discharge pump or the second discharge pump are configured to operate when both of the first discharge valve and the second discharge valve are closed to stop downstream flow through both of the first discharge line and the second discharge line past respective the first discharge valve and the second discharge valve.

7. The system of claim 5, further comprising:
a clearance mode wherein the clearance valve is configured to be open when the first discharge valve and the second discharge valve are simultaneously closed to stop downstream flow through both of the first discharge line and the second discharge line past respective the first discharge valve and the second discharge valve.

8. The system of claim 1, further comprising:
a sensor configured to determine flow past at least one of the first discharge pump or the second discharge pump.

9. The system of claim 1, further comprising:
a sensor configured to transmit a signal when a threshold level of the waste material is within the tank.

10. The system of claim 9, further comprising:
a controller configured to receive the signal to operate at least one of the first discharge pump or second discharge pump.

11. The system of claim 1, further comprising:
a sensor to determine that at least one of the first discharge line, the first discharge valve, the second discharge line, the second discharge valve, the first discharge pump, or the second discharge pump is obstructed.

12. The system of claim 1, further comprising:
a normal operation mode wherein the clearance valve is closed when the first discharge valve and the second discharge valve are simultaneously open to allow downstream flow through both of the first discharge line and the second discharge line past respective the first discharge valve and the second discharge valve.

13. The system of claim 2, further comprising:
a toilet fluidly coupled with the tank to allow material to move from the toilet to the tank at least in part due to an influence of the vacuum.

14. A method of operating a pump manifold system for waste material, the method comprising:
operating a first discharge pump to move the waste material along a first discharge line from a tank toward a discharge conduit;
providing a second discharge pump configured to move the waste material along a second discharge line from the tank toward the discharge conduit;
providing a clearance line fluidly coupling the first discharge line and the second discharge line at a position upstream of a first valve and a second valve with a clearance valve in a closed position to stop flow through the clearance line; and
when an obstruction is determined in at least one of the first discharge pump or the first discharge line,
opening the clearance valve to allow flow through the clearance line,
closing both of the first valve in the first discharge line and the second valve in the second discharge line,
stopping the operation of the first discharge pump, and
operating the second discharge pump.

15. The method of claim 14, further comprising:
providing the tank configured to store the waste material;
fluidly coupling the first discharge line to the tank; and
fluidly coupling the second discharge line to the tank.

16. The method of claim 14, further comprising:
sensing a threshold level of the waste material within the tank prior to the operating the first discharge pump.

17. The method of claim 14, further comprising:
operating the second discharge pump while operating the first discharge pump.

18. The method of claim 14, further comprising:
forming a vacuum in the tank.

19. The method of claim 18, further comprising:
fluidly coupling a toilet with the tank to allow waste material to move from the toilet to the tank at least in part due to an influence of the vacuum.

20. The method of claim 14, further comprising:
operating the pump manifold system in at least one of either (i) a normal operation mode with the first valve and the second valve open and the clearance valve closed or (ii) a clearance operation mode with the first valve and the second valve closed and the clearance valve open.
